(19) United States
(12) Patent Application Publication
(10) Pub. No.: US 2025/0123390 A1
(43) Pub. Date: Apr. 17, 2025

(54) DYNAMIC OCCUPANCY GRID FUSION WITH DIVERSE INPUTS

(71) Applicant: QUALCOMM Incorporated, San Diego, CA (US)

(72) Inventors: Vishnuu APPAYA DHANABALAN, Munich (DE); Ahmed Kamel SADEK, San Diego, CA (US); Avdhut JOSHI, San Marcos, CA (US); James POPLAWSKI, Canton, MI (US); Makesh Pravin JOHN WILSON, San Diego, CA (US)

(21) Appl. No.: 18/825,534

(22) Filed: Sep. 5, 2024

Related U.S. Application Data
(60) Provisional application No. 63/590,944, filed on Oct. 17, 2023.

(51) Int. Cl. G01S 13/86; G01S 13/89; G06T 7/70

(52) U.S. Cl. CPC G01S 13/867; G01S 13/865; G01S 13/89; G06T 7/70; G06T 2207/10028

(57) ABSTRACT

A method, for determining a dynamic occupancy grid, includes: obtaining radar measurement data from at least one radar sensor of an apparatus; obtaining camera-derived data based on at least one image obtained by at least one camera of the apparatus; and determining the dynamic occupancy grid based on the radar measurement data and the camera-derived data.

### CROSS-REFERENCE TO RELATED APPLICATIONS

This application claims the benefit of U.S. Provisional Application No. 63/590,944, filed Oct. 17, 2023, entitled “DYNAMIC OCCUPANCY GRID FUSION WITH DIVERSE INPUTS,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or information about other vehicles or objects (e.g., location, speed, heading, size, object type, etc.).

A state of an ego vehicle may be used as an input to a number of driver assistance functionalities, such as an Advanced Driver Assistance System (ADAS). Downstream driving aids such as an ADAS may be safety critical, and/or may give the driver of the vehicle information and/or control the vehicle in some way.

### SUMMARY

An example apparatus includes: at least one radar sensor; at least one camera; at least one memory; and at least one processor communicatively coupled to the at least one memory, the at least one radar sensor, and the at least one camera, and configured to: obtain radar measurement data from the at least one radar sensor; obtain camera-derived data based on at least one image obtained by the at least one camera; and determine a dynamic occupancy grid based on the radar measurement data and the camera-derived data.

An example method, for determining a dynamic occupancy grid, includes: obtaining radar measurement data from at least one radar sensor of an apparatus; obtaining camera-derived data based on at least one image obtained by at least one camera of the apparatus; and determining the dynamic occupancy grid based on the radar measurement data and the camera-derived data.

Another example apparatus includes: means for obtaining radar measurement data from at least one radar sensor; means for obtaining camera-derived data based on at least one image obtained by at least one camera of the apparatus; and means for determining a dynamic occupancy grid based on the radar measurement data and the camera-derived data.

An example non-transitory, processor-readable storage medium includes processor-readable instructions for causing at least one processor of an apparatus to: obtain radar measurement data from at least one radar sensor of an apparatus; obtain camera-derived data based on at least one image obtained by at least one camera of the apparatus; and determine a dynamic occupancy grid based on the radar measurement data and the camera-derived data.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example method of dynamic grid clustering.

FIG. 10 is a block diagram of an example functional architecture of an occupancy grid block of the device shown in FIG. 5.

FIG. 11 is a block diagram of another example functional architecture of an occupancy grid block of the device shown in FIG. 5.

FIG. 12 is a block diagram of another example functional architecture of an occupancy grid block of the device shown in FIG. 5.

FIG. 13 is a block flow diagram of a method for determining a dynamic occupancy grid.

### DETAILED DESCRIPTION

Techniques are discussed herein for determining and using occupancy grids. For example, measurements from multiple sensors, including one or more radars and a camera, may be obtained and measurements therefrom used to determine a dynamic occupancy grid. Techniques are discussed for incorporating input data in addition to radar data into determining a dynamic occupancy grid. For example, camera-derived data such as free space data, optical flow data, occupancy flow data, pixel depth data, and/or ground hazard detection data may be used in determining a dynamic occupancy grid. Lidar and/or HD (High Definition) map data may be used in determining a dynamic occupancy grid. Other techniques, however, may be used.

Items and/or techniques described herein may provide one or more of the following capabilities, as well as other capabilities not mentioned. Occupancy grid accuracy and/or reliability may be improved. Autonomous driving actions and/or autonomous driving safety may be improved, e.g., due to improved occupancy grid accuracy and/or reliability. An object may be classified as a dynamic object even though the object is presently stationary. Other capabilities may be provided and not every implementation according to the disclosure must provide any, let alone all, of the capabilities discussed.

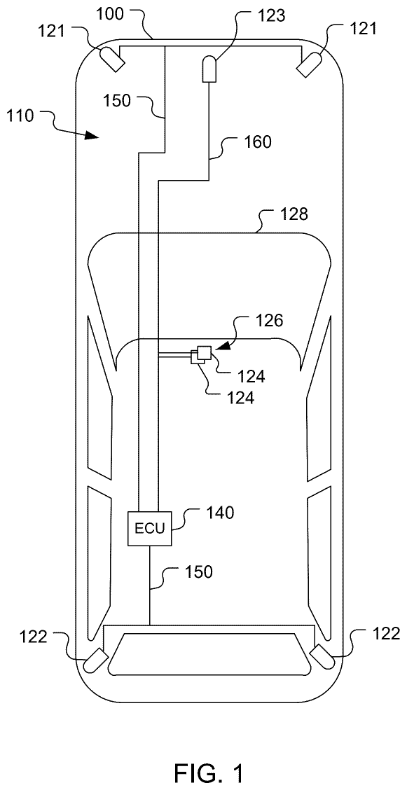

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

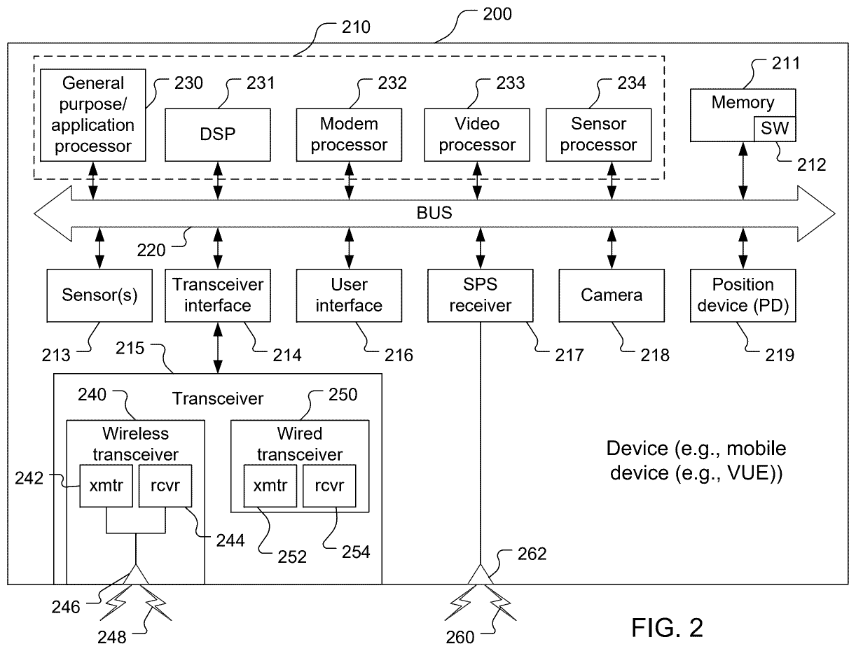

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

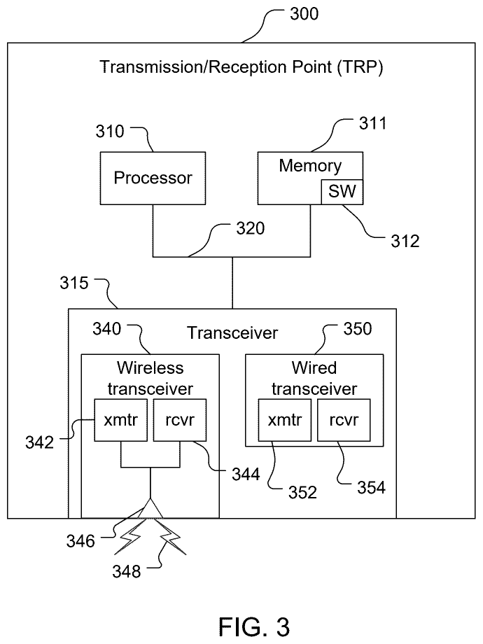

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

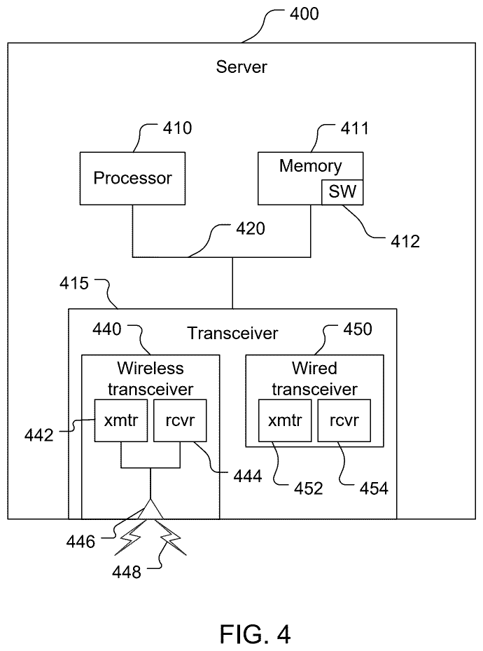

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

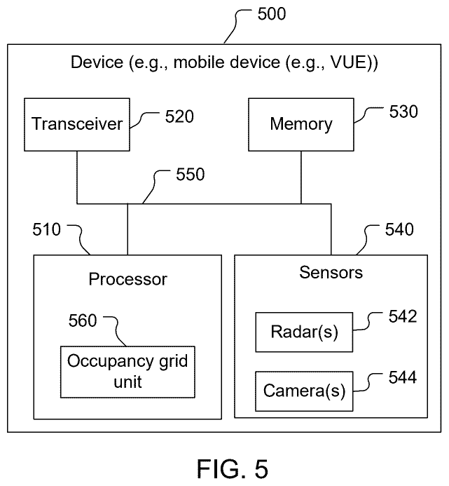

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensors 540 include one or more radar sensors 542 and one or more cameras 544, and possibly one or more other sensors (e.g., one or more lidar sensors).

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

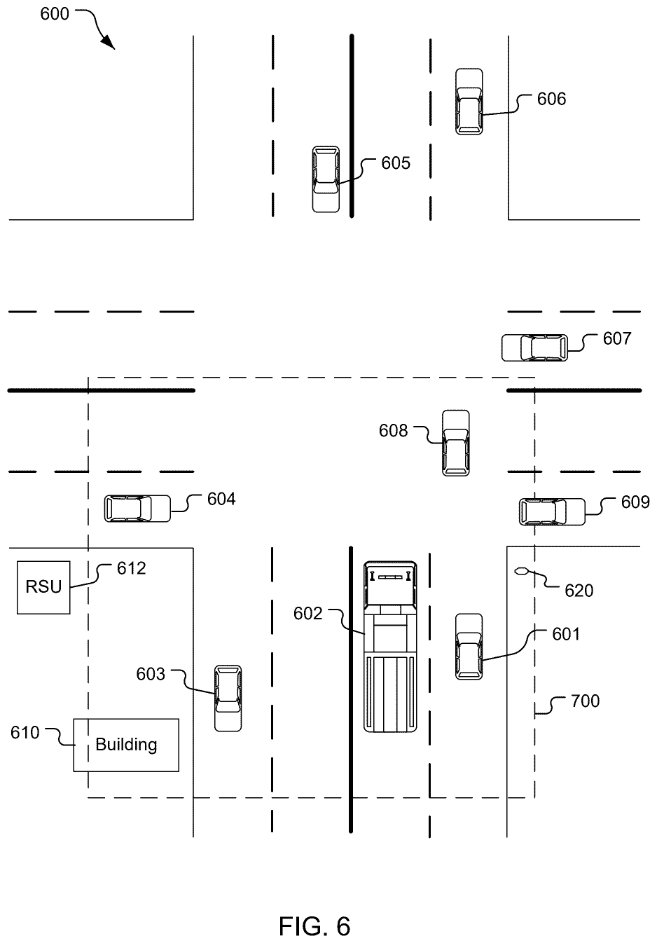

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

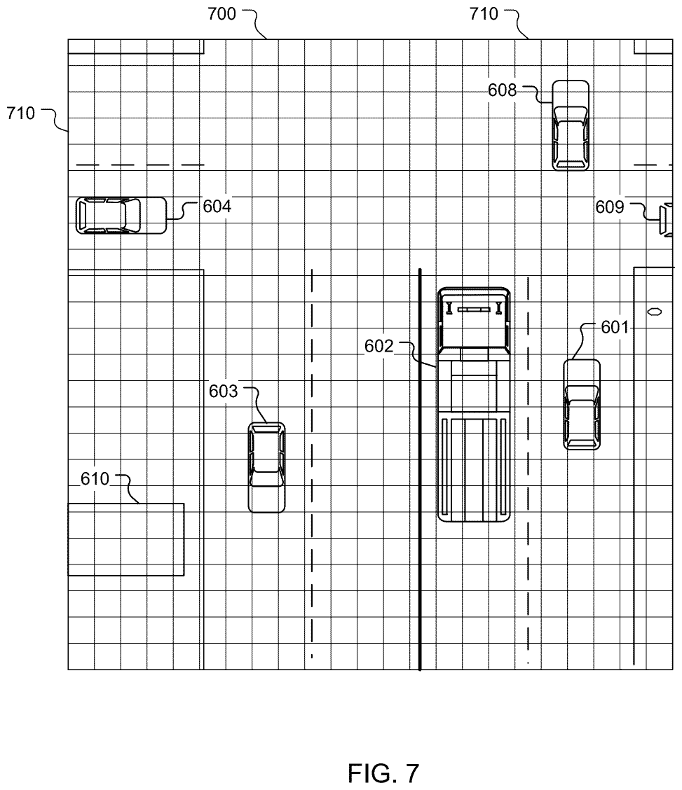

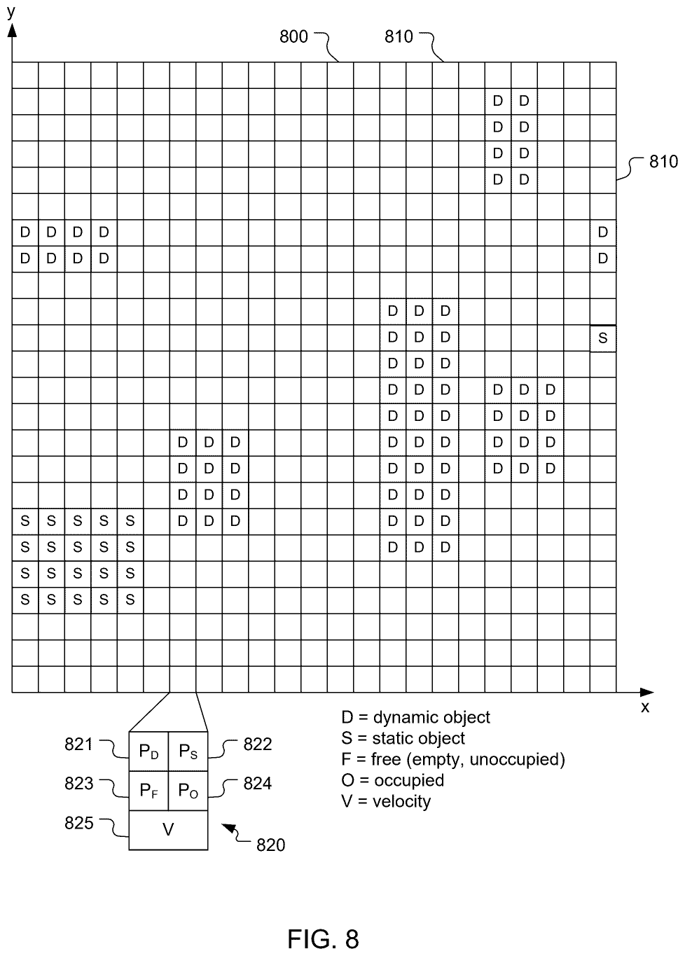

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static (S) or dynamic (D). Each of the probabilities may be a floating point value. The information as to what, if anything, occupies each of the sub-regions 710 may be obtained from a variety of sources. For example, occupancy information may be obtained from sensor measurements from the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from multiple sensors, e.g., of the sensors 540, such as from a radar system. Adding data from one or more cameras to determine the dynamic occupancy grid may provide significant improvements to the grid, e.g., accuracy of probabilities and/or velocities in grid cells.

In the context of robot planning and navigation in a local environment, occupancy grids may play a critical role. Subsets of occupancy grids include static occupancy grids (SOGs) and dynamic occupancy grids (DOGs). Static occupancy grids may identify static objects only, filtering out dynamic objects, or may assume that all observed objects are static (e.g., if desired information is what space around a device is free (unoccupied)). There may be a predictive aspect for DOGs such that movement of dynamic properties from one cell to another may be tracked and/or predicted. A dynamic occupancy grid may be used for a variety of applications such as autonomous driving, drone/humanoid navigation, AR/VR (Augmented Reality/Virtual Reality) scene composition, 3D reconstruction, etc. A dynamic occupancy grid may carry significantly richer information than a static occupancy grid such as velocity of cells, and/or more uncertainty estimates of states compared to a static occupancy grid. These features may be useful to downstream components, e.g., planning and control blocks. Sensor input for a dynamic occupancy grid may be lidar based only, radar based only, camera based only, or a combination of two or more of these. A DOG may operate on a lowest level of sensor data available. Higher levels of sensor data may be used for parametric approaches (discussed below). A dynamic occupancy grid alone may serve as a redundant path to a downstream path planning block. In case of safety critical applications like autonomous driving, having a redundant path may be essential for handling cases when a primary parametric approach to perception (using objects) fails.

A dynamic occupancy grid is a non-parametric approach to representing the environment, with the environment divided into cells and properties of one cell determined/analyzed independently of the other cells (although cells may be clustered based on common and/or similar values of properties between cells). In traditional sensor fusion, a parametric approach is generally followed where objects such as vehicles (e.g., cars, trucks) are represented by parameters such as position (e.g., x-y position, latitude-longitude position), orientation, size, and possibly shape. In a dynamic occupancy grid, a vehicle is represented in the form of grid cells along with velocity information in grid channels for each grid cell.

A DOG (e.g., a grid fusion block) may track dynamic cells over time, i.e., movement of one or more property values of one cell to another due to a dynamic object. Tracking over time may provide robustness against noise originating from sensors. A grid fusion algorithm may work with underlying states to track the environment over time. These states may include static, dynamic, free, and a combination of these for uncertainty. One or more underlying tracking mechanisms may be used to track states of the grid, for example, a Bayesian method, the Dempster-Shaffer theory, and/or a Hidden Markov model.

A sensor fusion, or grid fusion, or tracking technique may comprise grid creation, grid prediction, and grid updating. For grid creation, raw sensor measurements may be obtained, collected, and organized into a grid representation (the measurement grid, also called an occupancy grid) of an environment for an instance in time. The measurement grid may not include uncertainties, but the uncertainties may be determined over time due to the grid prediction and grid updating. For grid prediction, a state transition of grid cells may be predicted from one time (t−1) to a later time (t) based on motion model assumptions. The underlying grid prediction may be performed, for example, on a per-grid-cell basis or may be an efficient particle tracker for dynamic cells only. For grid updating, the measurement grid and the predicted grid may be fused.

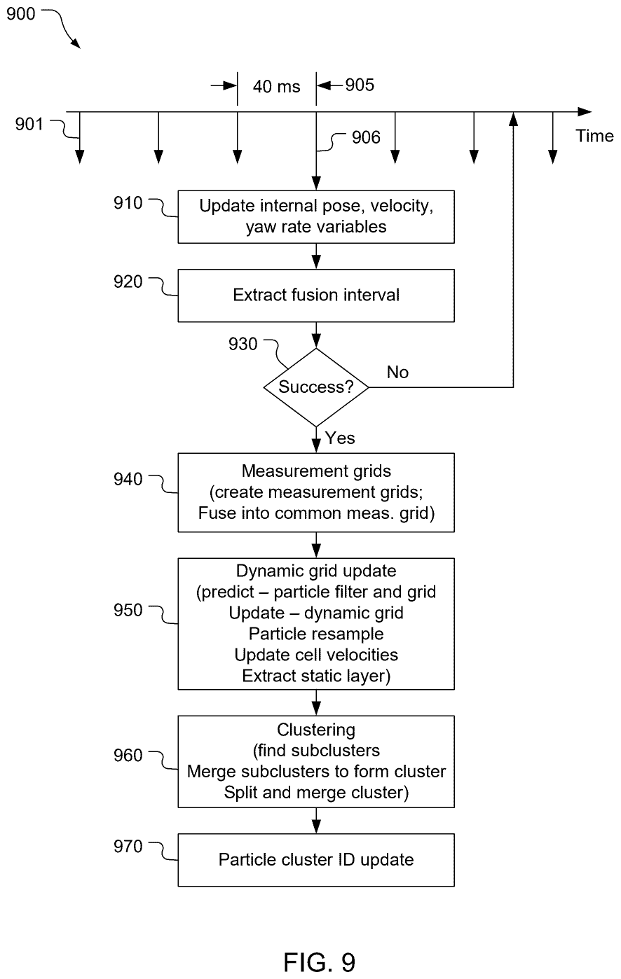

Referring also to FIG. 9, a method 900 of dynamic grid clustering includes the stages shown. The method 900 is, however, an example and not limiting. The method 900 may be altered, e.g., by having one or more stages added, removed, rearranged, combined, performed concurrently, and/or having one or more stages each split into multiple stages. At stage 910, intermittent interrupts 901 (e.g., at a periodic interval 905, e.g., every 40 ms in this example) occurs and a check is made by the processor 510 to determine whether sensor data are available (e.g., vehicle localization information such as speed). In this example, a check is made corresponding to an intermittent interrupt 906. If sensor data are available, then internal pose, velocity, and yaw rate variables are updated based on the sensor data. At stage 920, an extract fusion interval function is performed where sensor data are collected over time. At stage 930, the processor 510 determines whether one or more rules are met corresponding to success, such as at least a threshold number of radar measurements having been made over a specified time interval. If there is success (the rule(s) have been met), then the method 900 proceeds to stage 940, and otherwise returns to checking for data for updating at stage 910. At stage 940, a measurement grid is determined for each sensor for which sensor data are available. Values for grid points for each sensor (e.g., radar, camera, etc.) may be determined. For example, an M×N array (e.g., a 512×512 array) for each sensor may be determined and the arrays combined into a single M×N array of grid points. At stage 950, a dynamic grid update is performed. The processor 510 may determine a predicted grid (e.g., using a particle filter), and may fuse the measurement grid from stage 940 with the predicted grid. At stage 960, a clustering function is performed, e.g., with the processor 510 determining and grouping grid cells with similar velocities and positions (i.e., cells close to each other with similar velocities). At stage 970, a particle cluster ID update function is performed to track the cluster ID (from stage 960) within the particle.

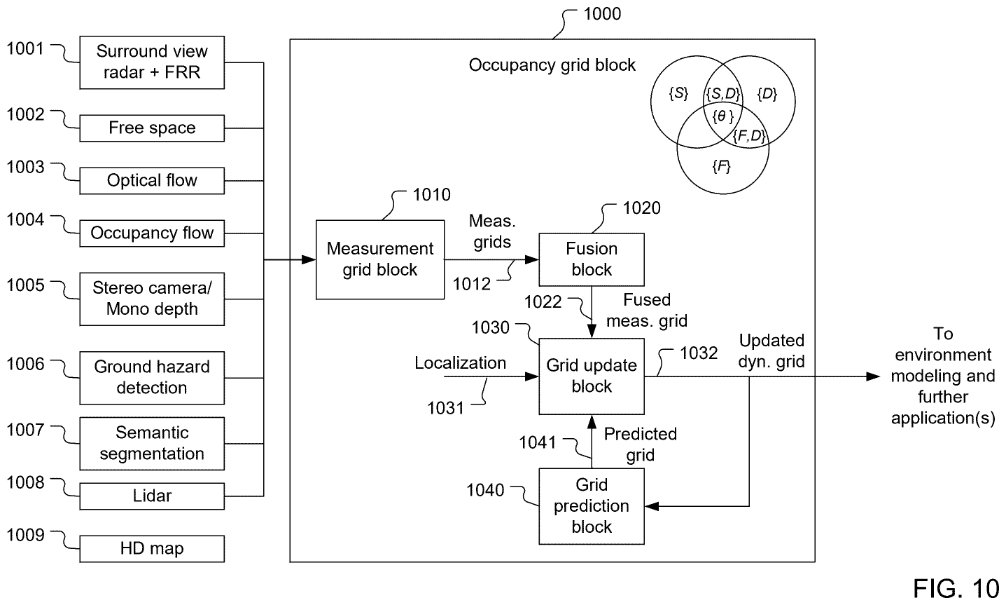

Referring also to FIG. 10, a functional architecture of an occupancy grid block 1000 (implementing an occupancy grid algorithm) of the device 500 includes functional blocks including a measurement grid block 1010, a fusion block 1020, a grid update block 1030, and a grid prediction block 1040. The occupancy grid block 1000 (which may be implemented by the occupancy grid unit 560) is configured to use inputs to update a world model output. The inputs may include ego motion data, sensor data, and contextual information such as an HD (High Definition) map. The occupancy grid block 1000, and in particular the measurement grid block 1010, in this example, may use as inputs surround view radar and FRR data 1001 (Far-Range Radar), camera free-space data 1002, optical flow data 1003, occupancy flow data 1004, stereo camera/mono depth pixel data 1005, ground hazard detection data 1006, semantic segmentation data 1007, lidar data 1008, and HD map data 1009.

The surround view radar and FRR data 1001 include ego motion inputs and radar inputs. The ego motion inputs include ego vehicle position, orientation, and velocity, which may be particularly useful for tracking applications. The radar inputs may include instantaneous and/or tracked sensor data. These data may include object location, object velocity, object classification, signal strength (e.g., such as RCS (Radar Cross Section) and/or SNR (Signal-to-Noise Ratio), and measurement uncertainty. The radar inputs may include instantaneous/tracked-object information such as object pose, object velocity, object classification, and uncertainty of one or more of these values. The radar data may be derived through classical signal processing algorithms and/or through one or more neural networks. Radar types may include Doppler radar/pulse Doppler radar/mmWave (millimeter-wave) radar, etc. Radar data may be provided in two dimensions and/or three dimensions. An array of radars may be mounted around the device 500.

The camera free-space data 1002, the optical flow data 1003, the occupancy flow data 1004, the stereo camera/mono depth pixel data 1005, the ground hazard detection data 1006, and the semantic segmentation data 1007 are data derived from camera-sensed data (e.g., one or more images). The camera(s) 544 may provide semantic information. The camera-derived data may be derived using computer vision techniques and/or one or more neural networks. The camera free-space data 1002 provide a bird's eye view (in two dimensions and/or three dimensions) representation of what an area around the ego vehicle (e.g., the device 500) is considered to be free of obstacles. For example, the free-space data 1002 may provide an indication of a distance from the device 500 to a nearest object (if any) for each of multiple angles relative to the device 500, e.g., each of 72 sectors each of 5° wide to provide a 360° free-space view around the device 500. The boundary of free space may have classification or semantic information (e.g., labels) such as car, barrier, road curb, pedestrian, etc. that may affect the nature of an output occupancy grid. The optical flow data 1003 provide indications of movement of pixels between different images taken at different times (e.g., showing movement of an object relative to the device 500). The optical flow data 1003 may include a velocity vector or shift vector for each pixel between the times corresponding to the different images. Using the optical flow data 1003, velocities of boundary points (between free (unoccupied) and non-free (occupied) regions) which are classified as dynamic may be estimated and supplied as an input to the occupancy grid algorithm. The optical flow data 1003 may be generated using computer vision techniques like Lucas-Kanade or one or more neural networks. The occupancy flow data 1004 may be derived from a single camera input or multiple camera inputs and may provide the occupancy probability, dynamic probability, and velocity of each grid cell (e.g., including motion prediction for each grid cell). The occupancy flow data 1004 may be directly presented in the BEV (bird's-eye-view) space using multiple cameras and applying one or more neural networks. The stereo camera/mono depth pixel data 1005 provide stereo camera and/or monocular depth information that may be used to estimate depth of pixel points in space. The depth pixel data 1005 may help project pixels accurately in the BEV space. The ground hazard detection data 1006 may provide a stixel-like representation for static objects or hazards. The ground hazard data 1006 may help enhance the derived static layer, that is a two-dimensional array with floating point values extracted from the set of outputs and represents static objects in the environment of the ego vehicle. The semantic segmentation data 1007 may comprise a camera signal with a per-pixel semantic classification label (e.g., road, car, VRU, etc.). The semantic segmentation data 1007 may improve the accuracy of determined static and dynamic mass values.

The lidar data 1008 and/or the HD map data 1009 may be used to determine a dynamic occupancy grid. The lidar data 1007 may provide a 3D lidar point cloud that may be used along with neural-network-based sematic segmentation (e.g., for each pixel) and/or a 3D bounding box to create a 2D input grid. The HD map data 1009 may be used to determine the dynamic occupancy grid, e.g., by filtering points outside an HD map or by ignoring object detections in an opposite side of traffic, in certain scenarios, from the ego vehicle.

The occupancy grid block 1000 (e.g., the occupancy grid unit 560) may be configured to use the inputs 1001-1009 to create measurement grids, determine a fused measurement grid from the measurement grids, perform grid prediction, and perform grid updating based on the fused grid and a predicted grid. The measurement grid block 1010 is configured to use the inputs 1001-1009 to determine a measurement grid 1012 (occupancy grid based on sensor measurements from a respective input of the inputs 1001-1008 and the HD map data 1009) for each sensor providing data as part of the inputs 1001-1008 and/or corresponding to the HD map data 1009. The fusion block 1020 may fuse the multiple measurement grids provided by the measurement grid block 1010 into a single, fused measurement grid 1022 by assessing sets of corresponding cells of the measurement grids to determine one or more values for corresponding cells of the fused measurement grid until the fused measurement grid is complete. Multiple occupancy grids may be fused to form a fused occupancy grid. To fuse the grids, one or more values (e.g., velocity, occupancy probability, static probability, dynamic probability, etc.) of each of multiple cells corresponding to the same geographic sub-region (or at least partially overlapping sub-regions) are assessed to determine one or more values of a cell of a fused occupancy grid corresponding to the geographic sub-region. For example, multiple values may be combined (e.g., averaged, weighted averaged, etc.) or one value from among multiple values may be selected (e.g., a maximum value such as a maximum velocity, or a value corresponding to a higher (or highest) probability). For example, a velocity may be selected that corresponds to the higher (or highest) occupancy probability of the cells assessed for fusion. The fusion block 1020 may fuse the measurement grids using, for example, the Bayesian method, or the Dempster-Shafer theory. The grid update block 1030 may use the fused measurement grid, a predicted grid provided by the grid prediction block 1040 (discussed below), and a localization input 1031 (including localization information of the device 500) to determine (e.g., using a Bayesian method or the Dempster-Shafer theory) an updated dynamic grid 1032. The localization input 1031 provides ego vehicle position, orientation, and velocity, etc. to help determine a new state of an occupancy grid. The localization input 1031 may come from the device 500 and/or from another device that filters signals from the device 500, cameras, and map information to determine ego vehicle position. The localization information 1031 may be used to determine position and velocity of other objects in the environment to determine the updated dynamic grid 1032. The updated dynamic grid 1032 may be used to derive a parametric representation of dynamic objects only or to create an obstacle fan from static objects. The obstacle fan is a representation of the environment, with the environment divided into angular sections, and the object(s) (if any) in each section represented by the respective range(s) to the object(s). The grid update block 1030 provides the updated dynamic grid 1032 to the grid prediction block 1040 and to an environment modeling algorithm (to determine an environment of the device 500) and possibly to one or more other further application(s) (e.g., to use the environment model for one or more purposes (e.g., autonomous driving decisions)). The grid prediction block 1040 uses the state of a current (e.g., of time t) tracked dynamic grid to predict the state of the grid at a future time (e.g., time t+1). For example, the fusion block 1020 may apply a particle filter to the updated dynamic grid 1032 to predict the states of dynamic particles to determine a predicted grid 1041 that the grid prediction block 1040 provides to the grid update block 1030.

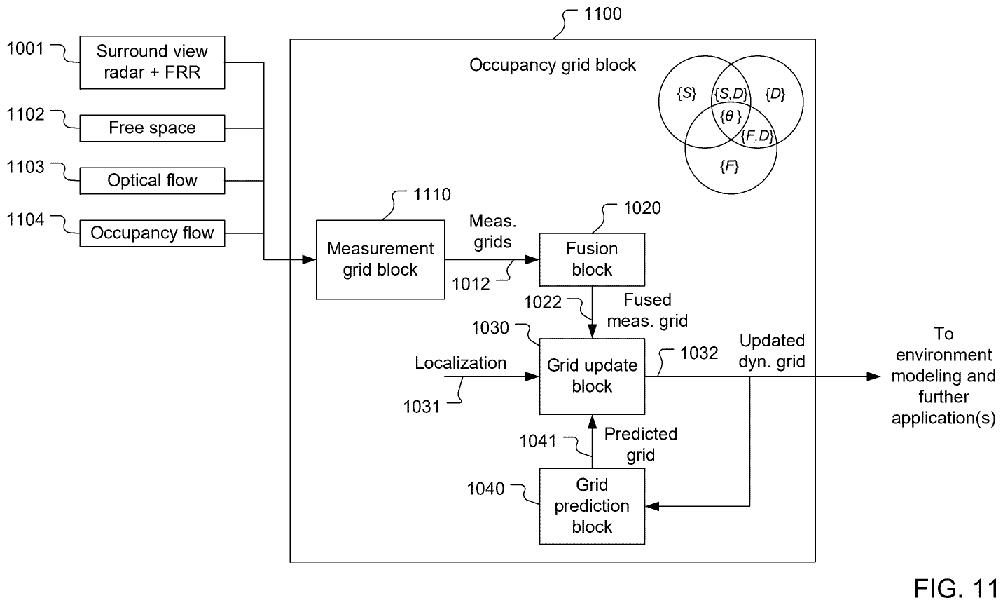

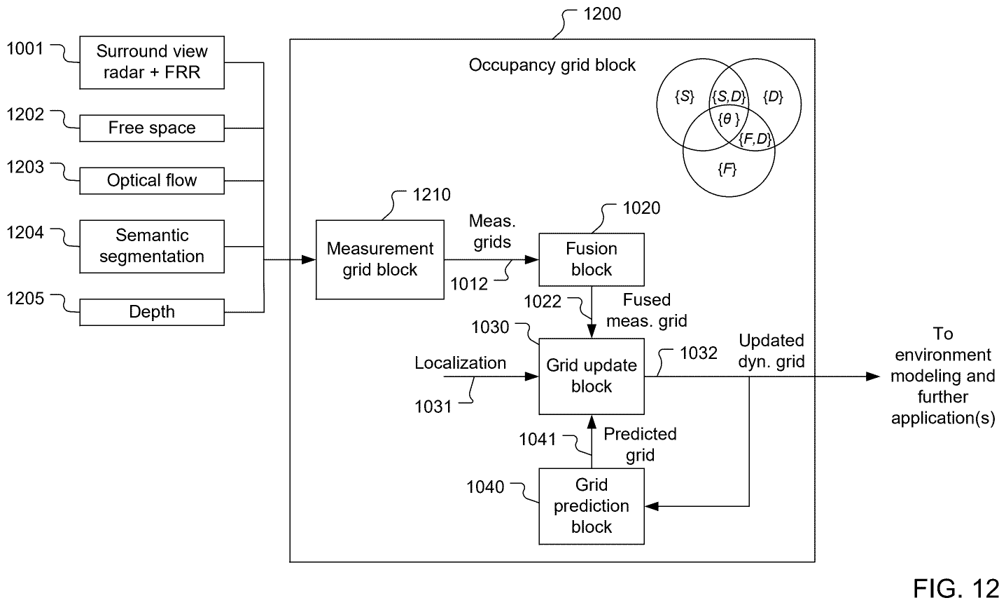

Other implementations of occupancy grid blocks may be used. For example, fewer than all of the inputs 1001-1009 may be provided to and/or used by a measurement grid block. For example, referring also to FIG. 11, a functional architecture of an occupancy grid block 1100 may use free-space data 1102, optical flow data 1103, and occupancy flow data 1104, all derived from measurements from multiple cameras, as well as the surround view radar and FRR data 1001 as inputs to a measurement grid block 1110 to determine measurement grids. As another example, referring also to FIG. 12, a functional architecture of an occupancy grid block 1200 may use free-space data 1202, optical flow data 1203, semantic segmentation data 1204, and depth data 1205, all derived from measurements from multiple cameras, as well as the surround view radar and FRR data 1001 as inputs to a measurement grid block 1210 to determine measurement grids.

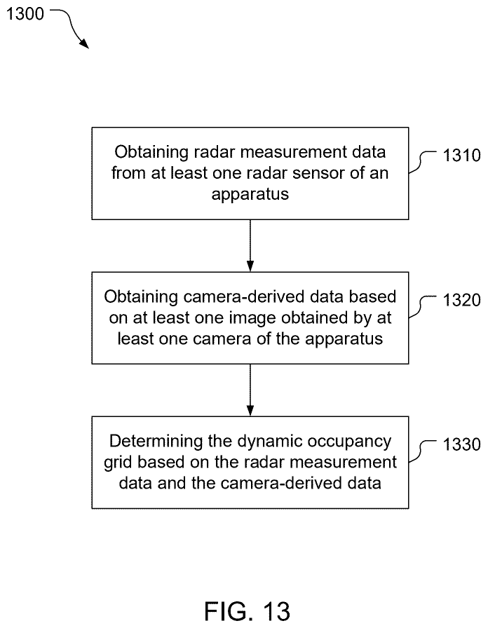

Referring to FIG. 13, with further reference to FIGS. 1-12, a method 1300 for determining a dynamic occupancy grid includes the stages shown. The method 1300 is, however, an example and not limiting. The method 1300 may be altered, e.g., by having one or more stages added, removed, rearranged, combined, performed concurrently, and/or having one or more stages each split into multiple stages.

At stage 1310, the method 1300 includes obtaining radar measurement data from at least one radar sensor of an apparatus. For example, the radar(s) 542 may make one or more radar measurements, e.g., for the surround view radar and FRR data 1001, and provide the radar measurement(s) to the occupancy grid unit 560 (possibly via the memory 530). The radar(s) 542, and the processor 510, possibly in combination with the memory 530, may comprise means for obtaining radar measurement data.

At stage 1320, the method 1300 includes obtaining camera-derived data based on at least one image obtained by at least one camera of the apparatus. For example, the camera(s) 544 may obtain one or more images and the processor 510, e.g., the occupancy grid unit 560, may determine camera-derived data, e.g., the camera free-space data 1002, the optical flow data 1003, the occupancy flow data 1004, the stereo camera/mono depth pixel data 1005, and/or the ground hazard detection data 1006. The processor 510, possibly in combination with the memory 530, may comprise means for obtaining camera-derived data.

At stage 1330, the method 1300 includes determining the dynamic occupancy grid based on the radar measurement data and the camera-derived data. For example, the processor 510, e.g., the occupancy grid unit 560, e.g., the grid update block 1030, determines the dynamic occupancy grid based on the radar data and the camera derived data, e.g., the surround view radar and FRR data 1001 and one or more of the camera free-space data 1002, the optical flow data 1003, the occupancy flow data 1004, the stereo camera/mono depth pixel data 1005, and the ground hazard detection data 1006. The processor 510, possibly in combination with the memory 530, may comprise means for determining the dynamic occupancy grid.

Implementations of the method 1300 may include one or more of the following features. In an example implementation, the camera-derived data comprise (1) free space data, or (2) optical flow data, or (3) occupancy flow data, or (4) depth data, or (5) ground hazard data, or a combination of two or more of (1)-(5). In another example implementation, the method 1300 includes obtaining lidar data by at least one lidar sensor of the apparatus, wherein determining the dynamic occupancy grid is based further on the lidar data. For example, the processor 510, e.g., the occupancy grid unit 560, e.g., the grid update block 1030, may determine the dynamic occupancy grid (e.g., the updated dynamic grid 1032) based on the lidar data 1008 (and possibly the HD map data 1009) in addition to the radar measurement data and the camera-derived data. In another example implementation, the method 1300 includes determining the dynamic occupancy grid is based further on high-definition map data. For example, the processor 510, e.g., the occupancy grid unit 560, e.g., the grid update block 1030, may determine the dynamic occupancy grid (e.g., the updated dynamic grid 1032) based on the HD map data 1009 (and possibly the lidar data 1008) in addition to the radar measurement data and the camera-derived data.

Also or alternatively, implementations of the method 1300 may include one or more of the following features. In an example implementation, the method 1300 further includes: determining a radar measurement grid based on the radar measurement data; determining at least one camera measurement grid based on the camera-derived data; and determining a fused measurement grid based on the radar measurement grid and the at least one camera measurement grid; wherein determining the dynamic occupancy grid is based on the fused measurement grid. For example, the processor 510, e.g., the occupancy grid unit 560, e.g., the measurement grid block 1010, may determine the measurement grids 1012, e.g., one or more radar measurement grids based on radar measurement from the radar(s) 542 and one or more camera measurement grids based on camera-derived data (derived from data from the camera(s) 544), and the processor 510, e.g., the occupancy grid unit 560, e.g., the fusion block 1020, may determine the fused measurement grid 1022 based on the radar measurement grid(s) and the camera measurement grid(s). The processor 510, e.g., the occupancy grid unit 560, e.g., the measurement grid block 1010, may determine the dynamic occupancy grid (e.g., the updated dynamic grid 1032) based on the fused measurement grid 1022. The processor 510, possibly in combination with the memory 530, may comprise means for determining the radar measurement grid, the at least one camera measurement grid, and the fused measurement grid. In a further example implementation, the method 1300 includes determining a predicted grid, wherein determining the fused measurement grid is based further on the predicted grid. For example, the processor 510, e.g., the occupancy grid unit 560, e.g., the grid prediction block 1040, may determine the predicted grid 1041 and the processor 510, e.g., the occupancy grid unit 560, e.g., the grid update block 1030, may determine the dynamic occupancy grid (e.g., the updated dynamic grid 1032) based on the predicted grid 1041. The processor 510, possibly in combination with the memory 530, may comprise means for determining the predicted grid. In a further example implementation, the method 1300 includes determining the dynamic occupancy grid based further on a localization input including localization information of the apparatus. For example, the processor 510, e.g., the occupancy grid unit 560, e.g., the grid update block 1030, may determine the dynamic occupancy grid (e.g., the updated dynamic grid 1032) based on the localization input 1031.

### Implementation Examples

Implementation examples are provided in the following numbered clauses.

Clause 1. An apparatus comprising:
at least one radar sensor;
at least one camera;
at least one memory; and
at least one processor communicatively coupled to the at least one memory, the at least one radar sensor, and the at least one camera, and configured to:
   obtain radar measurement data from the at least one radar sensor;
   obtain camera-derived data based on at least one image obtained by the at least one camera; and
   determine a dynamic occupancy grid based on the radar measurement data and the camera-derived data.

Clause 2. The apparatus of clause 1, wherein the camera-derived data comprise (1) free space data, or (2) optical flow data, or (3) occupancy flow data, or (4) depth data, or (5) ground hazard data, or a combination of two or more of (1)-(5).

Clause 3. The apparatus of either clause 1 or clause 2, wherein the apparatus further comprises at least one lidar sensor communicatively coupled to the at least one processor, and wherein the at least one processor is configured to determine the dynamic occupancy grid based on lidar data obtained from the at least one lidar sensor.

Clause 4. The apparatus of any of clauses 1-3, wherein the at least one processor is configured to determine the dynamic occupancy grid based on high-definition map data stored in the at least one memory.

Clause 5. The apparatus of any of clauses 1-4, wherein the at least one processor is configured to:
determine a radar measurement grid based on the radar measurement data;
determine at least one camera measurement grid based on the camera-derived data;
determine a fused measurement grid based on the radar measurement grid and the at least one camera measurement grid; and
determine the dynamic occupancy grid based on the fused measurement grid.

Clause 6. The apparatus of clause 5, wherein the at least one processor is configured to determine a predicted grid, and to determine the fused measurement grid based further on the predicted grid.

Clause 7. The apparatus of clause 6, wherein the at least one processor is configured to determine the dynamic occupancy grid based further on a localization input including localization information of the apparatus.

Clause 8. A method, for determining a dynamic occupancy grid, comprising:
obtaining radar measurement data from at least one radar sensor of an apparatus;
obtaining camera-derived data based on at least one image obtained by at least one camera of the apparatus; and
determining the dynamic occupancy grid based on the radar measurement data and the camera-derived data.

Clause 9. The method of clause 8, wherein the camera-derived data comprise (1) free space data, or (2) optical flow data, or (3) occupancy flow data, or (4) depth data, or (5) ground hazard data, or a combination of two or more of (1)-(5).

Clause 10. The method of either clause 8 or clause 9, further comprising obtaining lidar data by at least one lidar sensor of the apparatus, wherein determining the dynamic occupancy grid is based further on the lidar data.

Clause 11. The method of any of clauses 8-10, wherein determining the dynamic occupancy grid is based further on high-definition map data.

Clause 12. The method of any of clauses 8-11, further comprising:
determining a radar measurement grid based on the radar measurement data;
determining at least one camera measurement grid based on the camera-derived data; and
determining a fused measurement grid based on the radar measurement grid and the at least one camera measurement grid;
wherein determining the dynamic occupancy grid is based on the fused measurement grid.

Clause 13. The method of clause 12, further comprising determining a predicted grid, wherein determining the fused measurement grid is based further on the predicted grid.

Clause 14. The method of clause 13, wherein determining the dynamic occupancy grid is based further on a localization input including localization information of the apparatus.

Clause 15. An apparatus comprising:
means for obtaining radar measurement data from at least one radar sensor;
means for obtaining camera-derived data based on at least one image obtained by at least one camera of the apparatus; and
means for determining a dynamic occupancy grid based on the radar measurement data and the camera-derived data.

Clause 16. The apparatus of clause 15, wherein the camera-derived data comprise (1) free space data, or (2) optical flow data, or (3) occupancy flow data, or (4) depth data, or (5) ground hazard data, or a combination of two or more of (1)-(5).

Clause 17. The apparatus of either clause 15 or clause 16, further comprising means for obtaining lidar data, wherein the means for determining the dynamic occupancy grid comprise means for determining the dynamic occupancy grid based on the lidar data.

Clause 18. The apparatus of any of clauses 15-17, wherein the means for determining the dynamic occupancy grid comprise means for determining the dynamic occupancy grid based on high-definition map data.

Clause 19. The apparatus of any of clauses 15-18, further comprising:
means for determining a radar measurement grid based on the radar measurement data;
means for determining at least one camera measurement grid based on the camera-derived data; and
means for determining a fused measurement grid based on the radar measurement grid and the at least one camera measurement grid;
wherein the means for determining the dynamic occupancy grid comprise means for determining the dynamic occupancy grid based on the fused measurement grid.

Clause 20. The apparatus of clause 19, further comprising means for determining a predicted grid, wherein the means for determining the fused measurement grid comprise means for determining the fused measurement grid based on the predicted grid.

Clause 21. The apparatus of clause 20, wherein the means for determining the dynamic occupancy grid comprise means for determining the dynamic occupancy grid based on a localization input including localization information of the apparatus.

Clause 22. A non-transitory, processor-readable storage medium comprising processor-readable instructions for causing at least one processor of an apparatus to:
obtain radar measurement data from at least one radar sensor of an apparatus;
obtain camera-derived data based on at least one image obtained by at least one camera of the apparatus; and
determine a dynamic occupancy grid based on the radar measurement data and the camera-derived data.

Clause 23. The non-transitory, processor-readable storage medium of clause 22, wherein the camera-derived data comprise (1) free space data, or (2) optical flow data, or (3) occupancy flow data, or (4) depth data, or (5) ground hazard data, or a combination of two or more of (1)-(5).

Clause 24. The non-transitory, processor-readable storage medium of either clause 22 or clause 23, further comprising processor-readable instructions for causing the at least one processor to obtain lidar data, wherein the processor-readable instructions for causing the at least one processor to determine the dynamic occupancy grid comprise processor-readable instructions for causing the at least one processor to determine the dynamic occupancy grid based on the lidar data.

Clause 25. The non-transitory, processor-readable storage medium of any of clauses 22-24, wherein the processor-readable instructions for causing the at least one processor to determine the dynamic occupancy grid comprise processor-readable instructions for causing the at least one processor to determine the dynamic occupancy grid based on high-definition map data.

Clause 26. The non-transitory, processor-readable storage medium of any of clauses 22-25, further comprising processor-readable instructions for causing the at least one processor to:
determine a radar measurement grid based on the radar measurement data;
determine at least one camera measurement grid based on the camera-derived data; and
determine a fused measurement grid based on the radar measurement grid and the at least one camera measurement grid;
wherein the processor-readable instructions for causing the at least one processor to determine the dynamic occupancy grid comprise processor-readable instructions for causing the at least one processor to determine the dynamic occupancy grid based on the fused measurement grid.

Clause 27. The non-transitory, processor-readable storage medium of clause 26, further comprising processor-readable instructions for causing the at least one processor to determine a predicted grid, wherein the processor-readable instructions for causing the at least one processor to determine the fused measurement grid comprise processor-readable instructions for causing the at least one processor to determine the fused measurement grid based on the predicted grid.

Clause 28. The non-transitory, processor-readable storage medium of clause 27, wherein the processor-readable instructions for causing the at least one processor to determine the fused measurement grid comprise processor-readable instructions for causing the at least one processor to determine the fused measurement grid based on a localization input including localization information of the apparatus.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
at least one radar sensor;
at least one camera;
at least one memory; and
at least one processor communicatively coupled to the at least one memory, the at least one radar sensor, and the at least one camera, and configured to:
obtain radar measurement data from the at least one radar sensor;
obtain camera-derived data based on at least one image obtained by the at least one camera; and
determine a dynamic occupancy grid based on the radar measurement data and the camera-derived data.

2. The apparatus of claim 1, wherein the camera-derived data comprise (1) free space data, or (2) optical flow data, or (3) occupancy flow data, or (4) depth data, or (5) ground hazard data, or a combination of two or more of (1)-(5).

3. The apparatus of claim 1, wherein the apparatus further comprises at least one lidar sensor communicatively coupled to the at least one processor, and wherein the at least one processor is configured to determine the dynamic occupancy grid based on lidar data obtained from the at least one lidar sensor.

4. The apparatus of claim 1, wherein the at least one processor is configured to determine the dynamic occupancy grid based on high-definition map data stored in the at least one memory.

5. The apparatus of claim 1, wherein the at least one processor is configured to:
determine a radar measurement grid based on the radar measurement data;
determine at least one camera measurement grid based on the camera-derived data;
determine a fused measurement grid based on the radar measurement grid and the at least one camera measurement grid; and
determine the dynamic occupancy grid based on the fused measurement grid.

6. The apparatus of claim 5, wherein the at least one processor is configured to determine a predicted grid, and to determine the fused measurement grid based further on the predicted grid.

7. The apparatus of claim 6, wherein the at least one processor is configured to determine the dynamic occupancy grid based further on a localization input including localization information of the apparatus.

8. A method, for determining a dynamic occupancy grid, comprising:
obtaining radar measurement data from at least one radar sensor of an apparatus;
obtaining camera-derived data based on at least one image obtained by at least one camera of the apparatus; and
determining the dynamic occupancy grid based on the radar measurement data and the camera-derived data.

9. The method of claim 8, wherein the camera-derived data comprise (1) free space data, or (2) optical flow data, or (3) occupancy flow data, or (4) depth data, or (5) ground hazard data, or a combination of two or more of (1)-(5).

10. The method of claim 8, further comprising obtaining lidar data by at least one lidar sensor of the apparatus, wherein determining the dynamic occupancy grid is based further on the lidar data.

11. The method of claim 8, wherein determining the dynamic occupancy grid is based further on high-definition map data.

12. The method of claim 8, further comprising:
determining a radar measurement grid based on the radar measurement data;
determining at least one camera measurement grid based on the camera-derived data; and
determining a fused measurement grid based on the radar measurement grid and the at least one camera measurement grid;
wherein determining the dynamic occupancy grid is based on the fused measurement grid.

13. The method of claim 12, further comprising determining a predicted grid, wherein determining the fused measurement grid is based further on the predicted grid.

14. The method of claim 13, wherein determining the dynamic occupancy grid is based further on a localization input including localization information of the apparatus.

15. An apparatus comprising:
means for obtaining radar measurement data from at least one radar sensor;
means for obtaining camera-derived data based on at least one image obtained by at least one camera of the apparatus; and
means for determining a dynamic occupancy grid based on the radar measurement data and the camera-derived data.

16. The apparatus of claim 15, wherein the camera-derived data comprise (1) free space data, or (2) optical flow data, or (3) occupancy flow data, or (4) depth data, or (5) ground hazard data, or a combination of two or more of (1)-(5).

17. The apparatus of claim 15, further comprising means for obtaining lidar data, wherein the means for determining the dynamic occupancy grid comprise means for determining the dynamic occupancy grid based on the lidar data.

18. The apparatus of claim 15, wherein the means for determining the dynamic occupancy grid comprise means for determining the dynamic occupancy grid based on high-definition map data.

19. The apparatus of claim 15, further comprising:
means for determining a radar measurement grid based on the radar measurement data;
means for determining at least one camera measurement grid based on the camera-derived data; and
means for determining a fused measurement grid based on the radar measurement grid and the at least one camera measurement grid;
wherein the means for determining the dynamic occupancy grid comprise means for determining the dynamic occupancy grid based on the fused measurement grid.

20. The apparatus of claim 19, further comprising means for determining a predicted grid, wherein the means for determining the fused measurement grid comprise means for determining the fused measurement grid based on the predicted grid.
